(19) United States
(12) Patent Application Publication
(10) Pub. No.: US 2016/0204480 A1
(43) Pub. Date: Jul. 14, 2016

(54) METHOD AND DEVICE FOR STORING ELECTRICAL ENERGY IN ELECTROCHEMICAL ENERGY ACCUMULATORS

(71) Applicant: YOUNICOS AG, Berlin (DE)

(72) Inventors: Clemens Triebel, Berlin (DE); Carsten Reincke-Collon, Berlin (DE); Udo Berninger, Berlin (DE)

(21) Appl. No.: 14/897,212

(22) PCT Filed: Jun. 24, 2014
(86) PCT No.: PCT/EP2014/063281

§ 371 Date: Feb. 17, 2016

(30) Foreign Application Priority Data
Jun. 24, 2013 (DE) 10 2013 211 951.8

(51) Int. Cl. H01M 10/44; H02J 7/34; H01M 16/00; H02J 7/00; H01M 10/42; H01M 10/48

(52) U.S. Cl. CPC H01M 10/441; H01M 10/425; H01M 10/482; H01M 16/00; H02J 7/0029; H02J 7/34; H01M 2010/4271; H01M 2220/10; H02J 2007/0039

(57) ABSTRACT

In a method for storing electric energy in electrochemical energy accumulators and for exchanging electric energy with an electric energy distribution network via a power electronic system connecting the electrochemical energy accumulators with the electric energy distribution network the specific data and features of the electrochemical energy accumulators 2.1-2.N and the topology of the power electronic system 4.1-4.N; 31.M; 31.N, 32.N are transferred into data and features specific for the electric energy distribution network 11. A corresponding apparatus contains at least one base module or AC batteries 1.1-1.N with DC batteries 2.1-2.N having the same chemical and/or physical properties, a battery management system 20.1-20.N controlling and monitoring the DC batteries 2.1-2.N, a power electronic module 4.1-4.N, 31.N, 32.N, a power electronic module control means 40.1-40.N and an AC battery management 5.1-5.N with communication interfaces 15 to the battery management system 20.1-20.N.

The invention relates to a method and an apparatus for storing electric energy in electrochemical energy accumulators according to the generic part of claims 1 and 4.

For securing a sustainable energy supply, the amount of renewable energies rises due to the increasing amount of wind and solar power plants. Since the control of energy distribution networks for providing a constant grid voltage and grid frequency currently is effected by conventional power plants with rotating electric generators, which also remain connected with the energy distribution networks when the energy provided from wind and sun would be sufficient for the supply of the consumers connected to the energy distribution networks, the wind and solar power plants must be throttled down, so that the share to be contributed by the renewable energies in the energy supply is limited. To remove this limitation, a system for energy storage and grid control in electric energy distribution networks is required, which both can perform tasks of grid control and thereby allows a shutdown of conventional power plants, and feeds a sufficient amount of energy into an energy distribution network, when the energy provided from wind and sun is not sufficient for the supply of the consumers connected to the energy distribution networks.

For energy storage, electrochemical energy storage systems preferably are used in such a system because of the fast availability of electric power, which under electrotechnical aspects substantially differ by the C-rate, i.e. the ratio of power and energy. These differences chiefly result from different accumulator technologies with various electrode combinations, such as lead-acid accumulator, sodium-based high-temperature batteries, lithium-ion accumulators, redox-flow batteries, etc. However, due to differences in the design and manufacturing method of the individual manufacturers of electrochemical energy accumulators, considerable differences are obtained even with a similar cell chemistry. Furthermore, electrochemical energy storage systems differ in secondary features such as aging behavior, cycle stability, cycle depth, own consumption, self discharge, and other aspects.

A further essential electrotechnical aspect is the DC-voltage-side output voltage as well as the variance of the voltage between charged and discharged condition of the electrochemical energy storage systems. The electrotechnical features such as power, voltage and voltage variance require and provide for a multitude of topological possibilities for the connection of power electronic components such as DC/DC-converters and DC/AC-converters.

To optimally satisfy the electrotechnical requirements of a whole system, a combination of various electrochemical energy storage systems with different C-rates is desirable. However, this also results in a multitude of variants of topologies of power electronic components.

From DE 100 18 943 A1, for example, a photovoltaic off-grid system with a photovoltaic generator is known, which on the one hand is connected with a battery via a matching transformer and a bidirectional position controller and on the other hand provides an AC voltage on the output side via a stand-alone inverter. The energy management here is effected via a control and regulating means.

From EP 1 986 306 A1 an energy supply system is known, in which the energy produced by photovoltaic systems is stored in several storage battery units, downstream of which an inverter is provided for coupling the energy supply system to an AC voltage energy distribution network. By means of a control unit, the connection of the individual storage battery units to the energy distribution network is controlled.

From US 2011/029 16 06 A1 an energy storage system with a management system is known, which comprises two DC/DC-converters, an inverter, a control unit and a battery management system.

From AT 509 888 A4 a method for controlling electric energy accumulators is known, which consist of several battery units (cell stacks) each connected with a DC/DC converter with switching hysteresis. For optimizing the efficiency, the individual electric energy accumulators selectively are switched on and off, wherein different switching hystereses are achieved in that the switching hystereses of the DC/DC converters are parameterized with different switching points. There is furthermore provided a dynamic adaptation of the charging and discharging curves of the electric energy accumulators in dependence on the SOC (State of Charge) and SOH (State of Health) of individual energy accumulators or the entire system by a central control unit.

In an overall system composed of many electric energy accumulators and in particular in the case of an expansion of the system by including further, also spatially remote electric energy accumulators, the problem occurs that the central control unit must know the specific properties of each of the electric energy accumulators and consider the same in the control of the state of charge of the energy accumulator and the overall system, which leads to a considerable expenditure in the programming of the central control unit and to a significant susceptibility to failure of the overall system.

From the reference Atcitty, S. [et al.]: Summary of State-of-the-Art Power Conversion Systems for Energy Storage Applications (SANDIA REPORT SAND98-2019, September 1998) a compilation of a plurality of power electronic converter systems with inverters and DC/DC converters connected in series or in parallel is known, which are bidirectionally connected with a control unit and on the one hand are connected to an energy storage unit and on the other hand to an energy supply network or an AC voltage load.

When composing an overall system of a plurality of individual converter systems or when expanding such overall system by including additional converter systems, however, there also occurs the problem that to maintain a specified state of charge of the overall system and the capacity of the individual energy accumulators, the control units of the individual converter systems must be connected with a central control unit which must know the specific properties of the converter systems and consider the same in the control of the state of charge of the energy storage systems and the overall system, which increases the programming expenditure and the susceptibility to failure of the overall system and leads to limitations of the useful life of the energy accumulators.

It is the object underlying the present invention to provide a method and an apparatus for storing electric energy in electrochemical energy accumulators and for exchanging electric energy with an electric energy distribution network as mentioned above, which ensures the use of different electrochemical energy accumulators with uniform communication interfaces and provides for the use of different topologies of power electronic components and electrochemical energy accumulators independent of the respectively employed technology of the electrochemical energy accumulators and the topology of the power electronic components in a hybrid power plant.

According to the invention, this object is solved by a method with the features of claim 1.

The solution according to the invention provides a method for storing electric energy in electrochemical energy accumulators and for exchanging electric energy with an electric energy distribution network, which ensures the use of different electrochemical energy accumulators with uniform communication interfaces and provides for the use of different topologies of power electronic components and electrochemical energy accumulators independent of the respectively employed technology of the electrochemical energy accumulators by abstraction of the topology- and accumulator-specific properties, so that a hybrid power plant can be composed of differently configured, but identically behaving storage units or modules at a point of common coupling of the electric energy supply network and at the communication interfaces to form a superordinate battery power plant management system.

By transferring the specific data and features of the electrochemical energy accumulators and the topology of the power electronic system into data and features specific for the electric energy supply network
control problems are transferred, in order to realize the desired electrical behavior by inverters operated in parallel and controlled decentrally,
suitable operating concepts of hybrid power plants, i.e. power plants which are equipped with batteries of different battery technologies, such as sodium-sulfur batteries, lithium-ion batteries, accumulators on the basis of vanadium redox flow or fuel cells, are provided, and
uniform or abstract communication interfaces are created, which allow an operation and the depiction of batteries and battery power plants which are independent of special technical design variants.

Preferably, the specific data and features of the electrochemical energy accumulators and the topology of the power electronic system are combined in an abstract AC battery and transferred into the data and features of the electric energy distribution network, wherein the AC battery is controlled, monitored and regulated by means of an AC battery management.

The AC battery depicts the quantities characteristic for the respectively used battery technology, such as charging and discharging current, capacity, state of charge and the like, in quantities relevant for the electric energy distribution network, such as currently available and maximally providable power and currently absorbable and releasable energy by transformation of the quantities characterizing the battery technology.

With the provision of a base module designated as AC battery in contrast to a DC battery an interface uniform in terms of control is provided to a whole system, which creates the prerequisites for a use of different topologies of power electronic components and electrochemical energy accumulators with different technology.

The abstracting function of the AC battery management or the division into a battery-specific functionality creates an optimized operation on the basis of abstract battery models in conjunction with a battery power plant management. The AC batteries with a uniform energy-related behavior provide for the design of a power plant management which with different battery technologies can fulfill its task for example as hybrid power plant without technology-specific adaptations.

The definition of AC batteries, which contain identical or different topologies of power electronic systems such as inverters, converters and DC/DC converters, and DC batteries including fuel cells, which have the same or different chemical and/or physical properties, and which at their points of common coupling and with respect to their communication interfaces with a superordinate battery power plant management system show an identical behavior, provides for a simple control of an overall system composed of many AC batteries, a minimization of the susceptibility to failure of the overall system due to a defined control and detection of the state of charge (SOC) and state of health (SOH) of each individual AC battery, and an easy expansion of the overall system by including identical AC batteries, even when the same are arranged remote from each other, as well as an arbitrary exchange of individual AC batteries, without a change occurring at the point(s) of common coupling.

An apparatus for storing electric energy in electrochemical energy accumulators and for exchanging electric energy with an electric energy distribution network via a power electronic system connecting the electrochemical energy accumulators with the electric energy distribution network is characterized by at least one base module (AC batteries) comprising
an electrochemical energy storage module with direct-current batteries (DC batteries) having the same chemical and/or physical properties,
a battery management system controlling and monitoring the DC batteries,
a power electronic module,
a power electronic module control means, and
an AC battery management with communication interfaces (15) to the battery management system.

Via a generic model of the battery-typical operating limits and phenomena, the AC battery as functional element of an energy distribution network thus realizes a uniform depiction of the DC source for an energy application, in particular
a depiction of the dependence of the capacity on the operating regime,
taking account of the unsharpness of the determination of the state of charge in consideration of calibration cycles,
a uniform parametrization of the AC voltage behavior, in particular the control of the power electronic components, and
a depiction of relations relevant and specific for battery technologies between quantities such as current, ampere-hours, state of charge (SOC) in quantities relevant for an energy supply system such as currently available and maximally providable power and currently absorbable and releasable energy by means of suitable transformations of the battery quantities.

An AC battery consists of at least one DC/AC-converter and further power electronic components and battery units connected thereto on the DC voltage side and conceptionally serves as decoupling plane between a management system for the whole system for taking up, storing and releasing electric energy to an electric energy distribution network and the battery-technology-specific combination of power electronic components, DC batteries and, depending on the design variant, a transformer and forms the equivalent to a DC battery from the point of view of the electric energy technology.

In principle, the AC battery consists of
a DC battery with associated battery management system,
an inverter with inverter controller,
an AC battery management system, and
in the case of a design as medium-voltage battery either additionally of a medium-voltage transformer with power switch on the medium-voltage side or in use of a medium-voltage inverter merely additionally of a power switch on the medium-voltage side.

The aforementioned components of an AC battery represent placeholders for partial components more complex in terms of design, so that depending on the respective battery technology different topologies for inverters and DC batteries result from different marginal conditions such as for example the voltage swing of DC batteries dependent on the state of charge or the necessary intermediate circuit voltage for the output voltage of the inverters.

From the different marginal conditions the following variants result, for example:

In a first variant, the AC batteries include several electrochemical energy storage modules connected in parallel with DC batteries having the same chemical and/or physical properties and with a battery management system associated to each electrochemical energy storage module, which controls and monitors the electrochemical energy storage module.

In a second variant, the AC batteries include several electrochemical energy storage modules connected in parallel in groups with DC batteries having the same chemical and/or physical properties and with a battery management system associated to each electrochemical energy storage module, which controls and monitors each electrochemical energy storage module, wherein the electrochemical energy storage modules connected in parallel in groups are connected with an inverter via a DC/DC-converter associated to each group.

Alternatively, the AC batteries include several electrochemical energy storage modules connected in parallel with DC batteries having different chemical and/or physical properties and with a battery management system associated to each electrochemical energy storage module, which controls and monitors the electrochemical energy storage module.

In this embodiment, different types of DC batteries can be combined in groups in an AC battery, wherein the data of the respective DC battery groups are input into the AC battery management or are retrieved from the AC battery management by the battery management systems, so that the AC battery management is able to correspondingly control and monitor the different DC battery groups.

The power electronic modules can consist of an inverter, which on the DC side is connected to the electrochemical energy storage modules and on the AC side is connected to a power bus bar or an inverter connected to a point of common coupling directly as medium-voltage inverter or via a medium-voltage transformer and a medium-voltage power switch, or of at least one DC/DC converter connected to the electrochemical energy storage modules and of an inverter which on the DC side is connected to the DC/DC converter(s) and on the AC side is connected to a power bus bar directly or via a medium-voltage transformer and a medium-voltage power switch.

For providing a specified DC voltage, the electrochemical energy storage modules can include several series-connected DC batteries with the same chemical and/or physical properties.

AC batteries can be used both as low-voltage and as medium-voltage batteries in conjunction with different topologies of power electronic components.

Unless the inverter is designed as medium-voltage inverter, AC batteries formed as medium-voltage batteries contain a medium-voltage transformer connected with the output of a power electronic module, which via a medium-voltage power switch is connected with a power bus bar or a point of common coupling. The AC batteries contain two electrochemical energy storage modules with DC batteries having the same chemical and/or physical properties, which are connected with one inverter each, which are connected to the primary windings of a three-winding transformer which on the secondary side is connected with the power bus bar or a point of common coupling.

In this embodiment, the AC battery is formed as low-voltage battery in which the DC batteries are connected to an inverter directly or via a DC/DC-converter, wherein the AC battery is connected to a power bus bar or a point of common coupling via a transformer and a power switch.

Alternatively, the AC battery can be formed as medium-voltage battery in which the DC batteries are connected to an inverter directly or via a DC/DC-converter, but which includes the possibly realized medium-voltage transformer and the medium-voltage power switch, so that it can directly be connected with the power bus bar or the point of common coupling.

A system consisting of several AC batteries with one point of common coupling is referred to as battery power plant whose control must be designed such that assured grid-side system services are ensured, in that the distribution of applications and tasks to the different AC batteries is optimized, in order to ensure a reliable and durable functionality of the battery power plant.

In use in a grid-forming battery power plant, i.e. in off-grid operation, the AC battery for example fulfills a realization of the features
frequency control in dependence on the active power at which the AC battery behaves according to an operating static (“droop”), and
voltage control in dependence on the reactive power.

In use of the AC battery in a grid-following battery power plant or control power plant, the AC battery for example provides
a frequency-dependent active power contribution, and
a voltage-dependent reactive power contribution.

For each application, the AC battery fulfills a
consideration of the operating limits for inverters and DC batteries as well as the necessary maintenance requirements which concern both technical availability limits and regularly necessary maintenance work such as the calibration of direct-current battery modules or parts thereof for the reliable state-of-charge measurement or the start-up or shutdown of (partial) batteries,
provision of a uniform interface to the superordinate battery power plant management system independent of the special form of inverter battery topology and battery technology, and
provision of estimates of availability restrictions or power and energy demand for upcoming maintenance operations such as e.g. the state-of-charge calibration of direct-current battery modules.

As in use in a grid-forming battery power plant (off-grid operation) the AC batteries operated in parallel work as parallel voltage sources which divide the load produced at the point of common coupling between themselves, the load component of each individual AC battery is obtained by the battery power plant management system via the parametrization of the operating statics for active and reactive power via the interface. Among other things, this also provides for the asymmetric operation of the individual AC battery, in order to for example perform a calibration of the state-of-charge measurement.

A battery power plant formed as grid-forming power plant controls the power bus bar voltage and power bus bar frequency and provides short-circuit currents for triggering overcurrent protection mechanisms.

In operation as grid-following battery power plant (e.g. control power plant), the AC batteries operated in parallel work as parallel power sources which together provide the power required at the point of common coupling—e.g. in dependence on the grid frequency according to a required control static. The load component of each individual AC battery can be parametrized by the battery power plant management system via the uniform interface. Among other things, this also provides for the asymmetric operation of the individual AC battery, in order to for example perform a calibration of the state-of-charge measurement.

Beside the provision of active power, the parallel AC batteries also can be used for voltage maintenance at the point of common coupling (provision of reactive power in connection with a voltage control at the power bus bar).

Via communication interfaces, the AC battery management system preferably is connected with a battery power plant management system which actuates the medium-voltage power switches and a power switch connecting the point of common coupling with the energy distribution network.

As an alternative to the provision of grid system services or as grid-forming power plant, the battery power plant can be operated as hybrid power plant in conjunction with renewable energy sources and for example in load-following operation ensure the maintenance of feed-in limitations at the common feed-in point (“peak-shaving”), control a specified power at the point of common coupling of the energy distribution network in dependence on the grid frequency, a load sequence or the like.

With reference to several exemplary embodiments illustrated in the drawing the idea underlying the invention will be explained in detail. In the drawing:

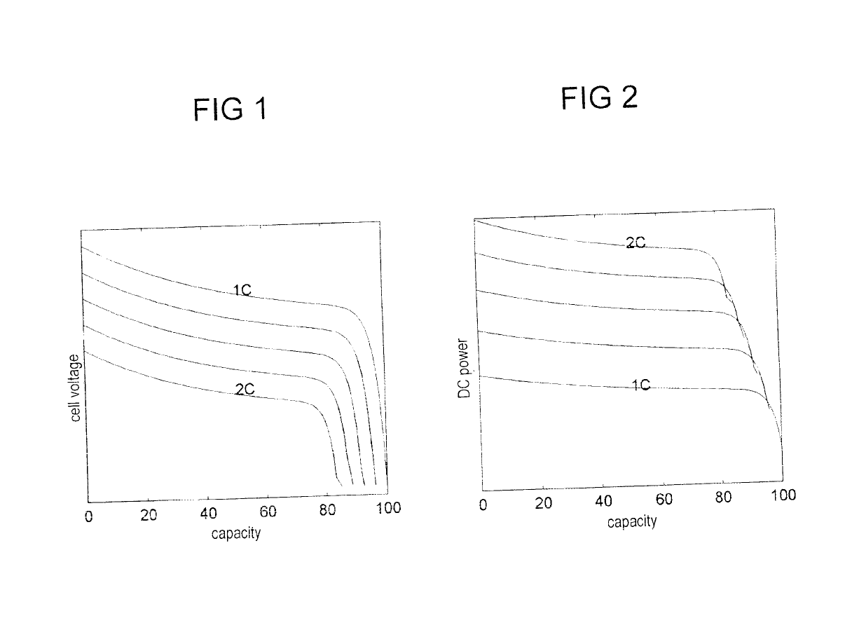

FIG. 1 shows a schematic representation of the cell voltage of lithium-ion batteries in dependence on the state of charge for different constant discharging currents;

FIG. 2 shows a schematic representation of the DC power of lithium-ion batteries in dependence on the state of charge;

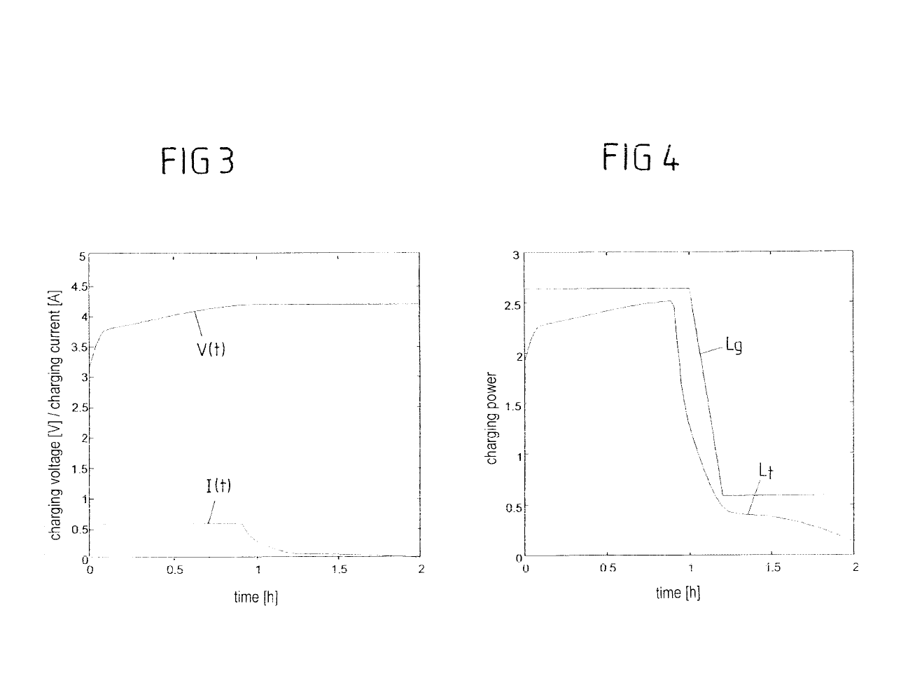

FIG. 3 shows a schematic representation of the course of the charging voltage and the charging current of a lithium-ion cell fully charged in the constant-current constant-voltage charging cycle;

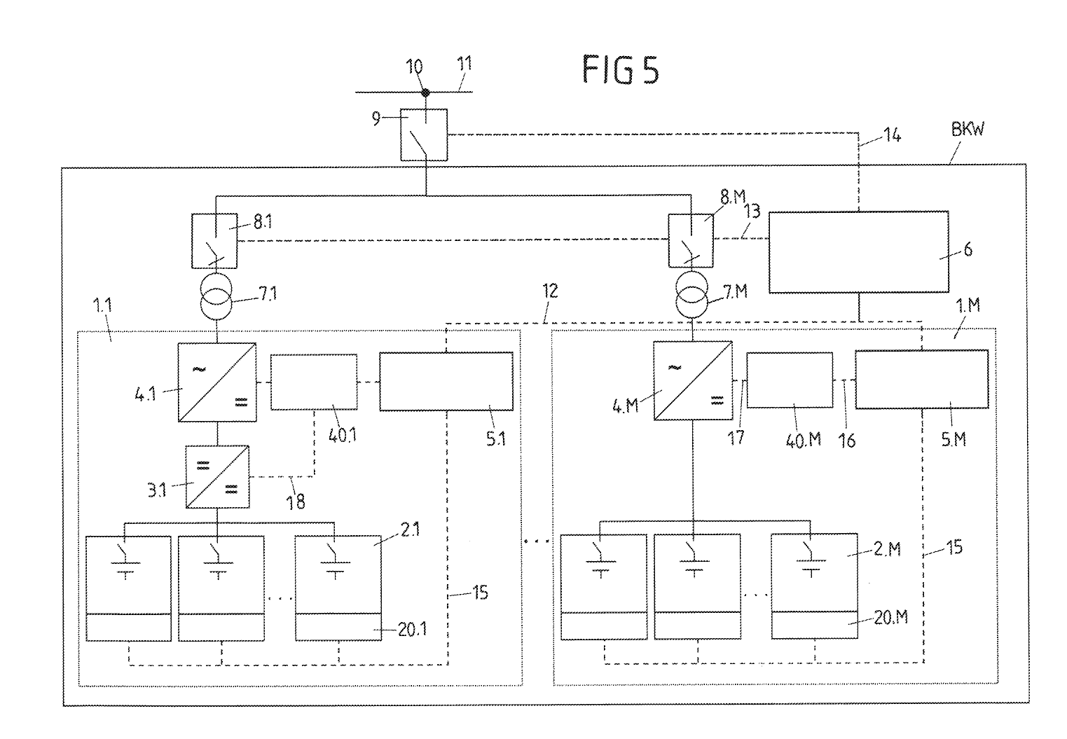

FIG. 4 shows a schematic representation of the course of the charging power of a lithium-ion cell and a possible simplified estimate of the charging power; and

FIGS. 5 to 8 show examples for AC batteries combined to a battery power plant with different topologies of the power electronic modules and DC batteries with partly different battery technologies, and

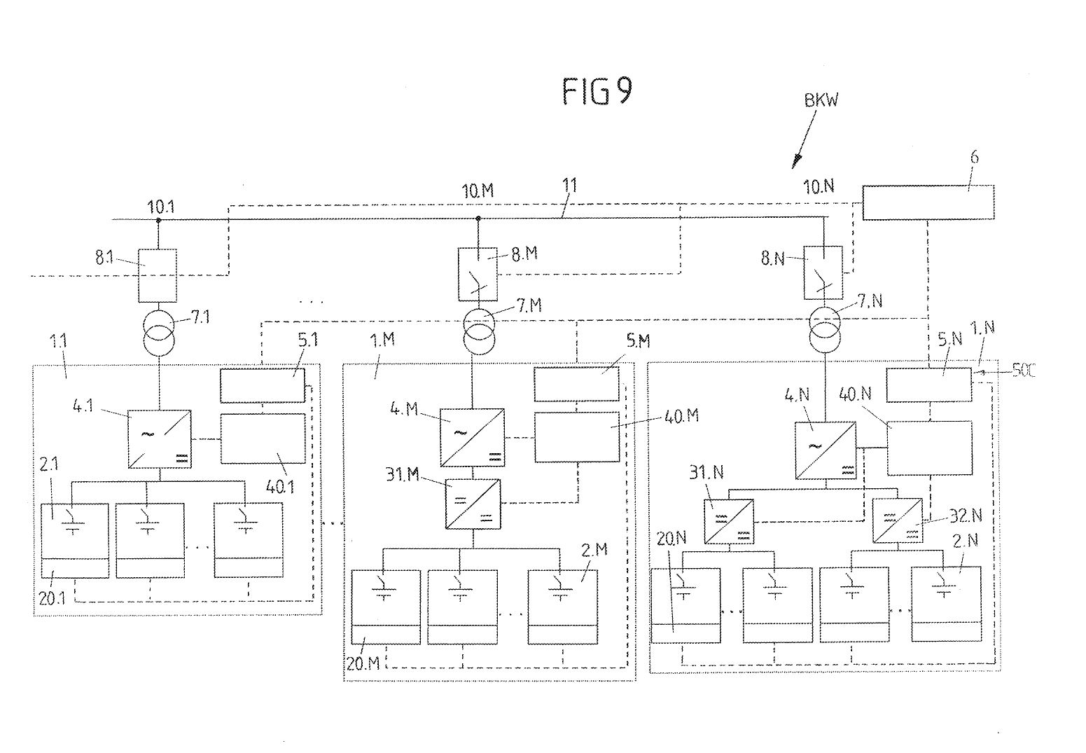

FIG. 9 shows a schematic representation of a battery power plant which consists of several AC batteries possibly arranged spatially separate from each other, which are connected with a battery power plant management system for the exchange of data and control signals and include different topologies of the power electronic modules and DC batteries with partly different battery technology.

Electrochemical energy accumulators or batteries are DC systems in construction, which depending on the battery technology show a different characteristic electrical behavior at an electrical interface.

Lithium-ion batteries with their very high ratio of power to energy (c-rate of 1 and higher) are particularly useful as short-term accumulators and for the compensation of large short-term fluctuations by the provision of control power.

Sodium-sulfur batteries, on the other hand, have a very high storage capacity with a c-rate of 1/6. Hence, these high-temperature batteries are particularly suitable for the compensation of daily fluctuations of wind and solar energy.

Accumulators on the basis of vanadium redox flow have almost no self discharge, so that they are excellently suitable for example as seasonal accumulators. Because the energy source of vanadium redox flow batteries does not age or wear, they have an almost unlimited durability with little maintenance effort and depending on requirement, power and energy can be separated and be scaled flexibly.

In FIGS. 1 to 4 examples for typical operating limits to be observed by an AC battery and properties of batteries with different battery technologies are shown with reference to the properties of lithium-ion batteries.

FIG. 1 shows the dependence of the cell voltage V on the state of charge (capacity) for different constant discharging currents, and FIG. 2 shows the corresponding DC power in dependence on the state of charge with different constant discharging currents.

Both qualitatively represented characteristic curves of lithium-ion batteries among other things show a different capacity depending on the discharging current, beside a typical cell voltage dependent on the state of charge. In addition, cell aging and hence also the remaining cell capacity depends on different influencing factors such as e.g. the history of the charging and discharging currents, the prevailing state of charge, and the temperature conditions.

Larger DC batteries consist of a suitable interconnection of individual cells to modules and of several modules to batteries, but generally are not prepared for energy applications, because
charging methods typically are not power-based, but current- and voltage-based, i.e. at ideal charging cycles the battery has variable power requirements to the outside, which depend on the state of charge,
battery management systems connected with the batteries provide battery information, such as the remaining capacity or the stored amount of energy, not in dependence on the operating regime, but with respect to a nominal operation.

As functional element of a battery power plant the AC battery thus fulfills the task of realizing a uniform depiction of the DC voltage source for an energy application via a generic model of the battery-typical operating limits and phenomena and among other things comprises
a depiction of the dependence of the capacity on the operating regime, i.e. the energy in dependence on the power,
a consideration of the unsharpness of the determination of the state of charge by taking account of calibration cycles,
a uniform parametrization of the AC voltage behavior by corresponding control of the power electronic component.

This encapsulation of battery-typical properties of an electrochemical energy accumulator or a DC battery as well as the requirements of an AC battery uniform in terms of energy provide for the design of a power plant management which with different battery technologies without technology-specific adaptations can fulfill its function for example as hybrid power plant.

When determining the state of charge of battery systems it is assumed that the state-of-charge measurements of battery systems generally are based on the formation of an energy balance by taking account of models for the current cell behavior. All models assume that with increasing operating period the state-of-charge measurement is subject to a more or less pronounced drift, so that the state-of-charge measurement of a battery system involves an indefiniteness which greatly increases with time. Therefore, all battery systems regularly must approach defined states of charge, for example a full charge, in order to calibrate the determination of the state of charge, wherein for carrying out the calibration the battery system employs a fixed operating regime.

As an example, FIGS. 3 and 4 illustrate the charging curve of a lithium-ion cell which is fully charged in the constant-current constant-voltage charging cycle.

FIG. 3 shows the temporal course of the charging voltage V and the charging current I during a charging operation, wherein in dependence on the actual state of charge the calibration of the state of charge starts at an applied cell voltage Uₜ₀ of for example 3.2 V. Until setting a constant cell voltage U_{K} of about 4.2 V, the lithium-ion cell requires a constant charging current. The actual charging power Pₜ(t) at constant charging voltage V and constant charging current I, which is necessary for this purpose and is shown in FIG. 4, increases in proportion to the cell voltage. In the subsequent transition to charging with constant voltage until setting the final charging current, the charging power greatly decreases according to FIG. 4 and subsequently continues to decrease in proportion to the charging current.

To enable a battery power plant management superordinate to the AC battery management system to secure the influence of the calibration of the state of charge on the point of common coupling, the AC battery offers an estimate of the calibration schedule, i.e. of the course of the charging power over time, by indicating the desire for a calibration. This is shown in FIG. 4 as curve P_{g}(t). It should be noted that this can only be an estimate which with greater distances between state-of-charge calibrations and greatly varying operating regimes of the AC battery involves an increasing indefiniteness.

Properties deviating therefrom are applicable for sodium-sulfur batteries and accumulators on the basis of vanadium redox flow. Since the exact requirements for an accumulator vary depending on the case of application and in part also on a project-specific basis, which concerns many properties, but especially the ratio of power and energy, which both in lithium-ion and in sodium-sulfur batteries is specified by the basic structure of the cells, different technologies are combined in a hybrid battery, if necessary, so that the advantages of the different technologies can be utilized.

FIGS. 5 to 7 show various examples for AC batteries combined to a battery power plant with different topologies of the power electronic modules, i.e. of the inverters or converters or DC/DC-converters, and different battery technologies, wherein the electric connection lines are shown in continuous lines and the communication connections are shown in broken lines.

FIG. 5 shows a block circuit diagram of a first exemplary embodiment of a battery power plant BKW with M AC batteries 1.1 to 1.M formed as low-voltage batteries, which are connected in parallel to a point of common coupling 10 and which each are connected with the point of common coupling 10 of an energy distribution network 11 via a transformer 7.1 to 7.M, a power switch 8.1 to 8.M and a PCC power switch 9. Each AC battery 1.1 to 1.M includes a plurality of groups of DC batteries 2.1 to 2.M connected in parallel, of which each group can comprise a plurality of series-connected DC batteries. Each of the DC battery groups 2.1 to 2.M includes a battery management system 20.1 to 20.M, which are connected with an AC battery management 5.1 to 5.M for each AC battery 1.1 to 1.M.

The battery management systems 20.1 to 20.M monitor the DC batteries and provide a communication interface to the AC battery management.

The first AC battery 1.1 includes a DC/DC-converter 3.1 connected with the DC battery groups 2.1 connected in parallel, which is connected with an inverter 4.1 to which a first transformer 7.1 is connected.

Further AC batteries have a power electronic topology like the first AC battery 1.1 or are constructed corresponding to the M-th AC battery 1.M, in which the DC batteries 2.M connected in parallel are directly connected with an inverter 4.M which is connected to a transformer 7.M. The different topology of the individual AC batteries 1.1 or 1.M for example is based on a different battery technology and/or a different number of series-connected DC batteries of the individual DC battery groups 2.1 or 2.M.

Via a communication line 16 the AC battery management 5.1 or 5.M of the AC batteries 1.1 to 1.M is connected with a power electronic controller 40.1 or 40.M, which with respect to the first AC battery 1.1 is connected with the inverter 4.1 via a communication line 17 and with the DC/DC-converter 3.1 via a communication line 18 or with respect to the M-th AC battery 1.1. via a communication line 17 with the inverter 4.M. Furthermore, the AC battery management 5.1 or 5.M is connected with the battery management systems 20.1 or 20.M of the DC batteries 2.1 to 2.M via a communication line 15.

A battery power plant management 6 associated to all AC batteries 1.1 to 1.M is connected with the AC battery management 5.1 to 5.M of the AC batteries 1.1 to 1.M via communication lines 12, and via a communication line 13 is connected with the power switches 8.1 to 8.M associated to the individual AC batteries 1.1 to 1.M and via a communication line 14 with the PCC power switch 9.

The AC battery management 5.1-5.N optimizes the use of the partial components of the AC batteries 1.1-1.N and thus for example provides for a maintenance of the partial components in ongoing operation, whereas the battery power plant management 6 controls the cooperation of the AC batteries 1.1-1.N on the AC side, calibrates the AC batteries 1.1-1.N and distributes the requirements for the battery power plant to individual AC batteries 1.1-1.N such that a homogeneous battery system is visible to the outside. As will be explained in detail below, both AC batteries 1.1-1.N with different power electronic topology and DC batteries with different battery technology or of a different type can be combined and their common use can be optimized.

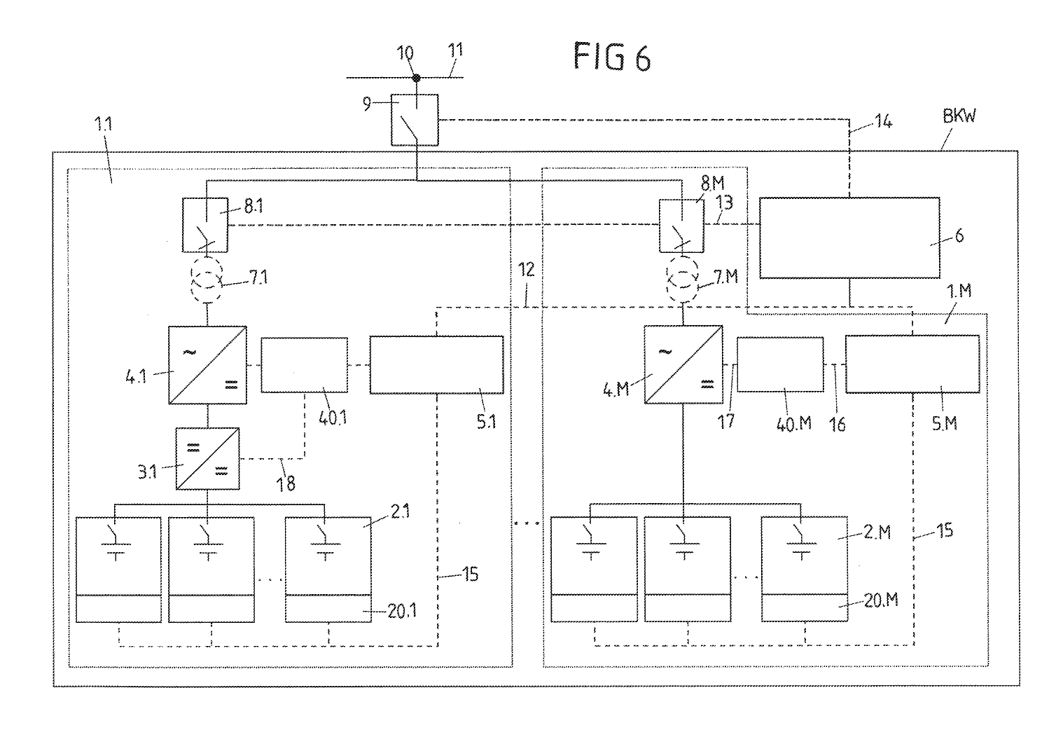

FIG. 6 shows a block circuit diagram of a second exemplary embodiment of a battery power plant BKW with M AC batteries 1.1-1.M formed as medium-voltage batteries, which are connected in parallel to a PCC power switch 9 and with the same construction as in the first exemplary embodiment according to FIG. 5 contain a medium-voltage power switch 8.1-8.M and, as needed, a medium-voltage transformer 7.1 to 7.M shown in broken lines.

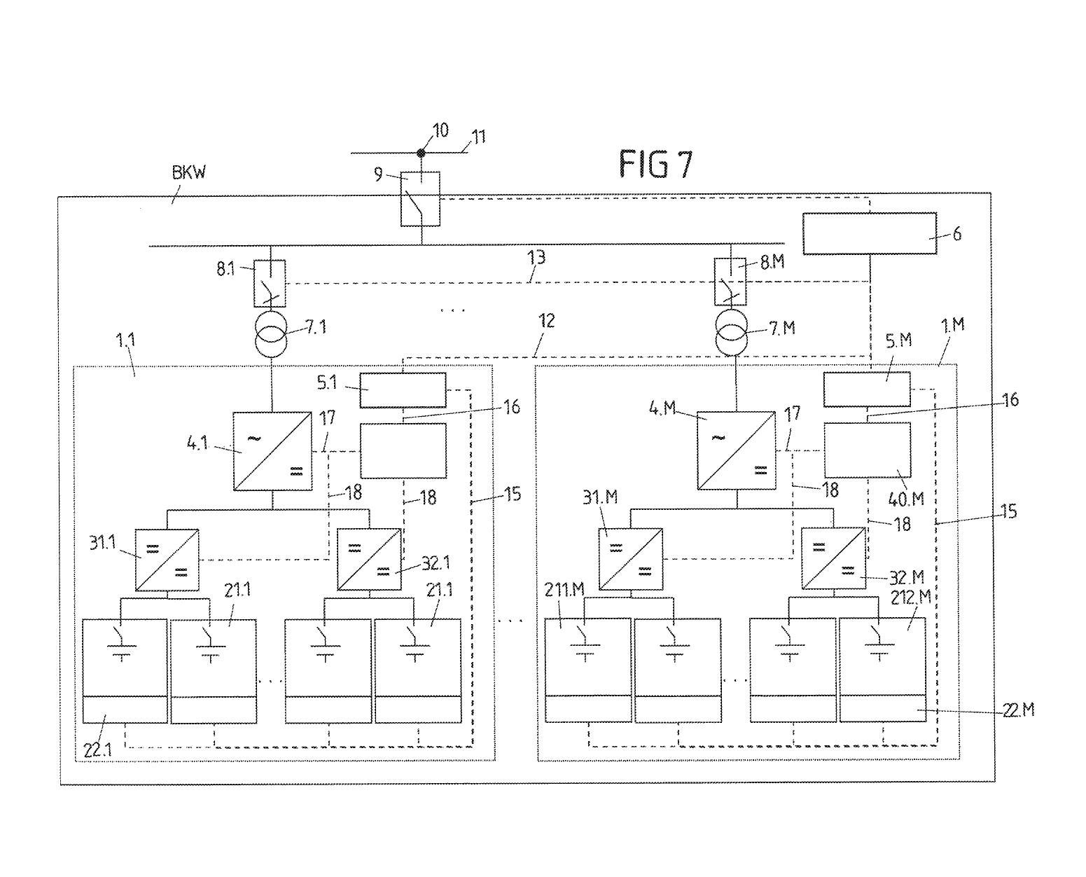

In a third embodiment of a battery power plant BKW shown in FIG. 7 in a schematic block circuit diagram, DC batteries 21.1 to 21.M connected in parallel are connected in groups each to one of two DC/DC-converters 31.1, 32.1 or 31.M, 32.M, which are connected with an inverter 4.1 or 4.M like in the embodiment according to FIG. 5.

In this embodiment, individual or all AC batteries 1.1-1.N can contain DC batteries 21.1-21.M each with the same or a different battery technology. For example, the AC battery 1.1 can include DC batteries 21.1 with the same battery technology, whereas the AC battery 1.N includes DC batteries 211.M, 212.N connected in parallel in groups, whose groups 211.M and 212.N each have the same battery technology or are of the same battery type, but which are formed differently from group to group.

In this configuration of an AC battery 1.N the AC battery management 5.M performs the control and monitoring of the groups 211.M, 212.N with different battery technology, after the corresponding data were input into the AC battery management 5.M or after the battery management systems 22.M provided in a group have output corresponding identification data to the AC battery management 5.M.

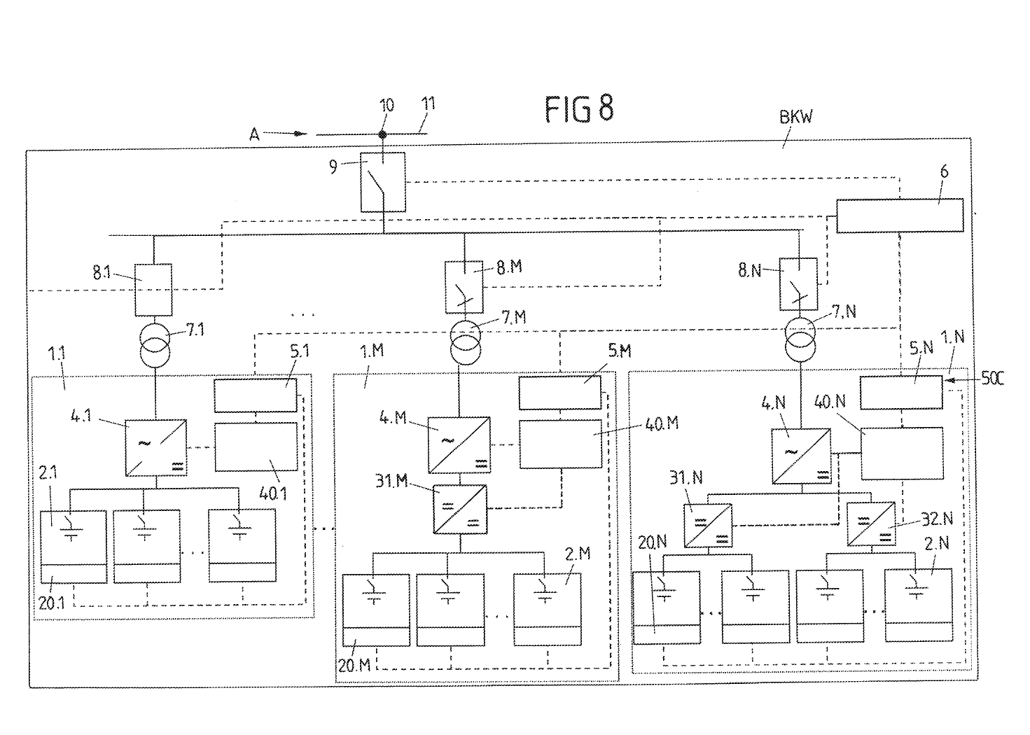

A fourth embodiment is schematically shown in FIG. 8 as block circuit diagram. In this embodiment of a battery power plant BKW the AC battery 1.1 includes DC batteries 2.1 connected in parallel, which are connected to an inverter 4.1, whereas the M-th AC battery 1.M contains DC batteries 2.M connected in parallel or DC battery racks 2.M formed of a series connection of several DC batteries, which are connected to a DC/DC-converter 31.M connected with an inverter 4.M.

Analogous to the embodiment according to FIG. 7, an N-th AC battery 5.N with DC batteries 2.N. with a battery management system 20.N, which are connected in parallel and are combined in groups, each are connected with an inverter 4.N via a DC/DC-converter 31.N, 32.N. As has been explained above with reference to FIG. 7, the N-th AC battery 1.N can combine the same or different battery technologies of the DC batteries 2.N with the same or a different battery technology, which combined in groups are connected to the one or other DC/DC converter 31.M, 32.M.

The embodiments according to FIGS. 7 and 8 are of course not limited to two groups of DC batteries 2.N connected in parallel with the same or a different battery technology, which each are connected to a DC/DC-converter 31.N, 32.N, but can comprise several groups with the same or a different battery technology, which each are connected to a DC/DC-converter.

In all exemplary embodiments shown in FIGS. 5 to 8, the battery power plant management 6 forms the central control level for the battery power plant, in which it combines the information provided by the generic AC batteries 1.1 to 1.M or 1.N, such as for example with regard to the indefiniteness of the state of charge, in order to optimize the operating point specifications for the individual AC batteries 1.1 to 1.N in dependence on the requirements to be fulfilled on the part of the energy distribution network 11 with respect to the power, energy or grid service.

The form of the parametrization of the total behavior depends on the respective case of application of the battery power plant. Whereas in off-grid operation schedules concerning the expected power band for a planning horizon are communicated on the part of an energy management system together with the desired control behavior around the operating points obtained and thus the battery power plant management 6 is allowed to make an optimization due to schedules, the requirements in use of a battery power plant for system services in the control power plant application result from a “grid code” and the current grid frequency.

An example for the superordinate operating tasks of the battery power plant management 6 to secure the fulfillment of external requirements at the point of common coupling 10 such as the specification of an expected power band and a power static by taking account of the internal requirements by the individual AC batteries 1.1 to 1.N is a calibration of the state of charge SOC of the AC battery 1.N according to FIG. 8, in which the battery power plant receives the power band to be covered by the battery power plant beside the desired operating statics at the point of common coupling 10 from the superordinate energy management system as characterization of the control behavior of the battery power plant around the operating points at the point of common coupling 10.

Due to specifications A at the point of common coupling 10, the battery power plant management 6 determines adapted operating points for the remaining batteries 1.1 to 1.M, in order to meet the specifications A at the point of common coupling 10, or it must dismiss the state-of-charge calibration possibly by assessment of the still rising indefiniteness of the state of charge of the battery power plant for the duration of the schedule. The specifications A at the point of common coupling 10 must be in correspondence with possible operating points calculated by the battery power plant management 6 and the internal requirements of the AC battery 1.N such as the planning of a state-of-charge calibration SOC for the AC battery 1.N, which in the form of the estimated power schedule for the duration of the calibration represent constraints for the operation of the AC battery 1.N.

Further requirements for the battery power plant management 6 can consist in the
handling of different battery technologies via the generic AC battery model,
distribution of central measurement quantities to achieve a stationary accuracy at the point of common coupling 10, and
optimization of the AC battery operating points on the basis of schedules or derived reference variables.

The battery power plant BKW need not necessarily be installed at one place, but also can be composed of many AC batteries or units arranged spatially remote from each other. An example for this is shown in FIG. 9.

In modification of the battery power plant schematically shown in FIG. 8, FIG. 9 shows several AC batteries 1.1 to 1.N connected to points of common coupling 10.1, 10.M and 10.N of an energy supply network 11 via one medium-voltage transformer 7.1 to 7.N each and one medium-voltage power switch 8.1 to 8.N each, which with their associated points of common coupling 10.1 to 10.N spatially can be far away from each other, but altogether provide a battery power plant BKW.

Analogous to the configuration of a battery power plant BKW according to FIG. 8, the AC battery management 5.1 to 5.N of the AC batteries 1.1 to 1.N is connected with a battery power plant management 6 via communication lines, which actuates the medium-voltage power switches 8.1 to 8.N connecting the AC batteries 1.1 to 1.N with the energy supply network 11 or separating said AC batteries from said energy supply network. The battery power plant management 6 represents the central control level for the battery power plant BKW composed of the individual AC batteries 1.1 to 1.N and combines the information provided by the AC batteries 1.1 to 1.N for example with respect to the indetermination of the state of charge of the individual AC batteries 1.1 to 1.N or their DC batteries 2.1 to 2.N, wherein the consistent configuration of the AC batteries 1.1 to 1.N at the energy transfer and communication interfaces not only ensures a simple configuration or programming of the control level of the battery power plant management 6, but also optimizes the operating point specifications for the individual AC batteries 1.1 to 1.N in dependence on the requirements to be fulfilled on the part of the energy supply network 11 with respect to the performance, energy or grid service such as keeping constant the grid frequency.

### LIST OF REFERENCE NUMERALS

1.1-1.N AC batteries
2.1-2.N DC batteries
3.1 DC/DC-converter
4.1-4.N inverters
5.1-5.N AC battery management
6 battery power plant management
7.1-7.N transformers
8.1-8.N power switches
9 PCC power switch
10 point of common coupling, PCC
11 energy distribution network
12-17 communication lines
20.1-20.N battery management systems
21.1-21.M DC batteries connected in parallel
31.1-32.M DC/DC-converters
40.1-40.N power electronic controllers
211.M, 212.M DC batteries of different battery technology
A specifications
BKW battery power plant
I charging current
P_{g} estimated charging power
Pₜ actual charging power
SOC state-of-charge calibration
V charging voltage

1. A method for storing electric energy in electrochemical energy accumulators and for exchanging electric energy with an electric energy distribution network via a power electronic system connecting the electrochemical energy accumulators with the electric energy distribution network,
characterized in
that the specific data and features of the electrochemical energy accumulators (2.1-2.N; 21.1-21.M; 211.M, 212.M) and the topology of the power electronic system (3.1; 4.1-4.N; 31.1-31.M; 31.N, 32.N) are transferred into data and features specific for the electric energy distribution network (11).

2. The method according to claim 1, characterized in that the specific data and features of the electrochemical energy accumulators (2.1-2.N; 21.1-21.M; 211.M, 212.M) and the topology of the power electronic system (3.1; 4.1-4.N; 31.1-31.M; 31.N, 32.N) are combined in an abstract AC battery (1.1-1.N) and transferred into the data and features of the electric energy distribution network (11) and that the AC battery (1.1-1.N) is controlled, monitored and regulated by means of an AC battery management (5.1-5.N).

3. The method according to claim 2, characterized in that the AC battery (1.1-1.N) depicts the quantities characteristic for the respectively used battery technology, such as charging and discharging current, capacity, state of charge and the like, in quantities relevant for the electric energy distribution network (11), such as currently available and maximally providable power and currently absorbable and releasable energy, by transformation of the quantities characterizing the battery technology.

4. The method according to claim 2 or 3, characterized in that several AC batteries (1.1 to 1.N) are connected with a battery power plant management system (6) via communication interfaces (12) and with a point of common coupling (10) of the energy supply network (11) via one power switch (8.1 to 8.N) each and a common PCC power switch (9).

5. The method according to claim 2 or 3, characterized in that several spatially separate AC batteries (1.1 to 1.N) are connected to a point of common coupling (10) of the electric energy supply network (11) and via communication lines (12) are connected with a common battery power plant management system (6).

6. An apparatus for storing electric energy in electrochemical energy accumulators and for exchanging electric energy with an electric energy distribution network via a power electronic system connecting the electrochemical energy accumulators with the electric energy distribution network,
characterized by
at least one base module (AC batteries 1.1-1.N) with
an electrochemical energy storage module with direct-current batteries (DC batteries 2.1-2.N, 21.1-21.M) having the same chemical and/or physical properties,
a battery management system (20.1-20.N) controlling and monitoring the DC batteries (2.1-2.N, 21.1-21.M),
a power electronic module (3.1, 4.1-4.N, 31.1-32.M),
a power electronic module control means (40.1-40.N), and
an AC battery management (5.1-5.N) with communication interfaces (15) to the battery management system (20.1-20.N).

7. The apparatus according to claim 6, characterized in that the AC batteries (1.1-1.N) include several electrochemical energy storage modules connected in parallel with DC batteries (2.1-2.N, 21.1-21.M) having the same chemical and/or physical properties and with a battery management system (20.1-20.N) associated to each electrochemical energy storage module, which controls and monitors the electrochemical energy storage module.

8. The apparatus according to claim 6 or 7, characterized in that the power electronic modules (3.1, 4.1-4.N, 31.1-32.M) consist of an inverter (4.1-4.N) which on the DC side is connected to the electrochemical energy storage modules and on the AC side is connected to a power bus bar or a point of common coupling (10) directly or via a medium voltage transformer (7.1-7.N).

9. The apparatus according to at least one of the preceding claims 6 to 8, characterized in that the power electronic modules (3.1, 4.1-4.N, 31.1-32.M) consist of at least one DC/DC-converter (3.1, 31.1-32.M) connected to the electrochemical energy storage modules and of an inverter (4.1-4.N) which on the DC side is connected to the DC/DC-converter(s) (3.1, 31.1-32.M) and on the AC side is connected to a power bus bar or a point of common coupling (10) directly or via a medium-voltage transformer (7.1-7.N).

10. The apparatus according to claim 8 or 9, characterized in that the AC batteries (1.1-1.N) include several electrochemical energy storage modules connected in parallel in groups with DC batteries (2.1-2.N, 21.1-21.M) having the same or different chemical and/or physical properties and with a battery management system (20.1-20.N) associated to each electrochemical energy storage module, controlling and monitoring each electrochemical energy storage module, and that the electrochemical energy storage modules connected in parallel in groups are connected with an inverter (4.1-4.N) via a DC/DC-converter (3.1, 31.1-32.M) associated to each group.

11. The apparatus according to at least one of the preceding claims 6 to 10, characterized in that the electrochemical energy storage modules include several series-connected DC batteries (2.1-2.N, 21.1-21.M) with the same chemical and/or physical properties.

12. The apparatus according to at least one of the preceding claims 6 to 11, characterized in that the AC batteries (1.1-1.N) are formed as medium-voltage batteries and are connected with a power bus bar or a point of common coupling (10) via the power electronic module (4.1-4.N) and a medium-voltage power switch (8.1-8.N).

13. The apparatus according to claim 12, characterized in that the output of the power electronic module (4.1-4.N) is connected with the medium-voltage power switch (8.1-8.N) via a medium-voltage transformer (7.1-7.N).

14. The apparatus according to claim 12 or 13, characterized in that the AC batteries (1.1-1.N) contain two electrochemical energy storage modules with DC batteries (2.1-2.N, 21.1-21.M) having the same chemical and/or physical properties, which each are connected with an inverter (4.1-4.N), and that the inverters (4.1-4.N) are connected to the primary windings of a three-winding transformer which on the secondary side is connected with the power bus bar or a point of common coupling (10).

15. The apparatus according to at least one of the preceding claims 6 to 14, characterized by at least two AC batteries (1.1-1.N) forming a battery power plant (BKW), which directly or via a medium-voltage power switch (8.1-8.N) or via a medium-voltage power switch (8.1-8.N) and a medium-voltage transformer (7.1-7.N) are connected to one point of common coupling (10) and include electrochemical energy storage modules (2.1-2.N) with the same or different chemical and/or physical properties.

16. The apparatus according to at least one of the preceding claims 6 to 15, characterized in that at least two AC batteries (1.1-1.N) forming a battery power plant (BKW) have different topologies for the power electronic modules (3.1, 4.1-4.N, 31.1-32.M).

17. The apparatus according to claim 16, characterized in that the AC batteries (1.1-1.N) contain
an inverter (4.1) connected with electrochemical energy storage modules (2.1) and/or
a DC/DC-converter (31.N) connected with electrochemical energy storage modules (2.N) connected in parallel and an inverter (4.N) connected with the DC/DC-converter (31.N) and/or
electrochemical energy storage modules (2.N) connected in parallel in groups and with one DC/DC-converter (31.N, 32.N) each connected to an inverter (4.N).

18. The apparatus according to at least one of the preceding claims 6 to 17, characterized in that as grid-forming power plant the battery power plant (BKW) consisting of several AC batteries (1.1-1.N) controls the voltage and frequency of the energy distribution network (11) and provides short-circuit currents for triggering overcurrent protection mechanisms.

19. The battery power plant according to claim 18, characterized in that the battery power plant (BKW) operates as power source and power drain and that the power released by the AC batteries (1.1-1.N) to the energy distribution network (11) is controlled in dependence on the grid frequency of the energy distribution network (11).

20. The apparatus according to at least one of the preceding claims 6 to 19, characterized in that via communication interfaces (12) the AC battery management (5.1-5.N) is connected with a battery power plant management system (6) which actuates the medium-voltage power switches (8.1-8.N) and a PCC power switch (9) connecting the point of common coupling (10) with the energy distribution network (11).

21. The battery power plant according to at least one of the preceding claims 6 to 20, characterized in that the battery power plant (BKW) is operated as hybrid power plant in conjunction with renewable energy sources and controls a specified power at the point of common coupling (10) of the energy distribution network (11) in dependence on the grid frequency.
